(19) United States
(12) Patent Application Publication
(10) Pub. No.: US 2011/0208648 A1
(43) Pub. Date: Aug. 25, 2011

(54) BEARING INFORMATION ON A CARD

(75) Inventor: Ahmad Abdullah Alothaimeen, Riyadh (SA)

(73) Assignee: Samba Financial Group, Riyadh (SA)

(21) Appl. No.: 13/059,565

(22) PCT Filed: Aug. 19, 2009
(86) PCT No.: PCT/GB2009/002021

§ 371 Date: May 10, 2011

(30) Foreign Application Priority Data
Aug. 19, 2008 (GB) 0815142.5
Apr. 9, 2009 (GB) 0906423.9

(51) Int. Cl. G06Q 40/00; G06K 19/00; G01C 21/00

(52) U.S. Cl. 705/39; 235/487; 701/207; 701/213; 701/220

(57) ABSTRACT

A financial transaction card is supplemented by position determining means which determines position coordinates for the card. The determined position is compared with a predetermined position stored in the memory to provide bearing data on the predetermined position from the position of the card. The card also includes a display for indicating the bearing. The card is particularly useful for indicating the bearing of the Kaaba from the position of the card.

### CROSS REFERENCE

This application is a United States national phase of co-pending international patent application No. PCT/GB2009/002021, filed Aug. 19, 2009, which claims priority to Great Britain patent application number 0906423.9, filed Apr. 9, 2009 and Great Britain patent application number 0815142.5, filed Aug. 19, 2008, the disclosures of which are incorporated herein by reference.

### BACKGROUND OF THE INVENTION

This invention relates to a card for indicating a bearing to another position.

According to the Islamic faith it is part of the daily life of the Faithful to devote a certain amount of time in prayer and contemplation each day. This devotional duty includes the need for the person at prayer to face the Kaaba in Mecca. The direction of the Kaaba from a certain position is known as the Qibla. It is not always possible to know by reference to outside indicators in which direction it is necessary to face.

A compass is the obvious device for indicating direction. However, it has significant disadvantages in this context. First, it indicates north and by deduction any other compass heading, but it does not indicate direction to a point on the earth. It is not of great use for the Faithful unless they already have some knowledge of the position of the Kaaba relative to the person's location. The compass is not good for ascertaining the actual bearing of the Kaaba from the person's position.

There are generally situations in which a user will want to know bearing and, possibly, distance to a certain position on the earth.

The Global Positioning System (GPS) is one of a number of location finding systems which are now available. It is one of several known techniques that can be used to establish a user's location on the earth by trilateration. Bearing information can be obtained by a moving user taking more than one GPS measurement. On land it is used in plotting a route from a user's position to a destination. At sea it is used in plotting a distance and bearing to a waypoint or destination. The complexity of the functionality of a typical GPS system does not lend itself to use in daily life. In all such systems it is necessary to key in data on the destination of interest and select various functions, such as fastest or shortest route on land, or the selection of waypoints at sea. Because of this, the typical functionality of GPS systems requiring various keys and buttons has not lent itself to transient daily use because of the size of such systems and the complexity of the set-up procedures.

To a large extent the multi-functional nature of a typical GPS system determines the size of the user's GPS receiver/processor as there is a limit to the size of buttons/keys, etc. that a user can comfortably manipulate. Likewise, the need for detail in the display of GPS data, such as an image of the land between the user and the destination, puts a practical limit on the minimum size of display that can be used.

Various Qibla indicating devices have been proposed. Some more recent proposals have suggested the use of GPS technology, such as a prayer mat including a GPS receiver. This is far from convenient to carry about with GPS. Others have proposed utilising existing display technology to include a GPS output, such as that in a mobile telephone. Examples of this are disclosed in WO06/007179, WO02/065151 and US 2003/0103002. By their nature, such devices include relatively large screens to display the many and varied functions that are provided on them. However, mobile telephones and other ‘feature rich’ devices are also inherently limited in their minimum size so that they are not necessarily the most convenient devices to carry around even though they are being miniaturised.

The average person in many parts of the world will generally be assumed to carry various items with them. For example, it is often the case that the average person would carry at least one financial transaction card with them along with other more or less essential items such as a wallet and a wristwatch.

The financial transaction card can take many forms such as a credit card, loyalty card or other instrument for effecting financial transactions. They are mostly made of a plastics material to a standard shape and size. They are characteristically small and thin so that they can be carried by a bearer with minimal difficulty.

Originally, all the data associated with the card was carried on a magnetic strip. More recently ‘chip and PIN’ technology has led to the magnetic strip being supplemented by a microchip and memory storage in the same dimensions of the original financial transaction card standard. The ‘chip’ and/or the magnetic strip constitute means for storing financial transaction information for using the card.

### SUMMARY OF THE INVENTION

The inventors have recognised that the purpose of a device for indicating the direction of a predetermined point on the earth is better divorced from the sophistication of those everyday devices bearing a sophisticated display. All that is required is a simple indicator of bearing to the specified position. However, where such a device can be incorporated into an everyday device it will be preferable to it being yet another item to have to carry around.

According to an embodiment disclosed there is provided a card, having the width and length of those of a financial transaction card, comprising means for storing data, position determining means operable to determine position data for the card, means for comparing a determined position for the card from the position determining means with a predetermined position stored in the means for storing and to provide bearing data on the predetermined position from the determined position of the card, and output means for indicating the said bearing.

In a particularly advantageous form the card is a financial transaction card. The conventional financial transaction card is designed to be as unobtrusive as possible. It is not designed to carry an animated display. However, by recognising that the display for indicating the bearing of a predetermined position can be rudimentary, and so does not have to compromise the benefits of size and shape of the transaction card, one particular form of the invention utilises the dimensions of an existing item commonly carried by members of the public for an enhanced purpose. Likewise, fixing the predetermined position to which a bearing is required from the position of the card eliminates the need for a sophisticated user interface which, again, avoids compromising the dimensions of the standard financial transaction card. The user is now able to determine with confidence the bearing to a prescribed place, such as the Kaaba. A preferred system on which the position determining means may be based is GPS. However, other position determining systems are known. Some use multilateration (e.g. trilateration) as the basis for the position determining. Any position determining system is applicable to this invention as long as it can be miniaturised for use in a card, such as a financial transaction card.

Preferably, the card includes means for supplying electrical power to the output means to indicate the bearing. In one form this may include a timer which automatically activates the means on the card by which the output data is generated. Alternatively, the means for supplying electrical power may comprise a device for user actuation of the output means on the card.

The means for supplying power may also enable the means for comparing to provide the bearing data in a similar way. The means for supplying power is preferably rechargeable.

Preferably, the card also includes means for actuating the position determining means.

In a particularly convenient form the means for supplying electrical power are arranged to act to enable the output means, the means for comparing and the position determining means. Using a timer to automatically activate the means on the card has the particular advantage of conserving energy by only providing electrical power at the appropriate times in the day, for example, when the user has to pray towards Mecca. Alternatively, providing the card with a user actuator device will also conserve power.

As energy saving is very important in the confined space available in something as small as a financial transaction card, another way of minimising power consumption is to arrange for the various means for producing the bearing indication to automatically power down after a predetermined period.

The means for producing the bearing indication may be powered by a source of electrical energy mounted on the card. This may be a storage cell or other device such as a solar cell.

When the output means are a display it is conveniently a variable marker in the form of a pointer headed in the appropriate direction.

In an alternative embodiment the card also carries a compass and an output indicating a compass direction. This embodiment may also include a separate display of the compass data or compass data may be displayed on the bearing display.

The predetermined position may be uploaded into the storage means through an interface on the card.

Embodiments disclosed also include in combination a financial transaction card, having a first source of electrical power, and a charging device having means for transferring energy for storage by the first source and a body for receiving the card in an energy transferring relationship therewith.

Also disclosed is a financial transaction card comprising processing means and storage means for storage of electrical energy which are operably connected with the processing means, and means for receiving energy for charging the storage means with electrical energy.

### BRIEF DESCRIPTION OF THE DRAWINGS

The invention will now be described by way of example with reference to the accompanying drawings in which:

FIG. 1 is a schematic block diagram of the functional features of a card as described;

FIG. 2 is a plan view of a card as described;

FIG. 3 is a schematic block diagram of the functional features of a card as described according to a further embodiment;

FIG. 4 is a plan view of a printed circuit board for the card as described according to the further embodiment;

FIG. 5 is a perspective view illustrating the assembly of the printed circuit board for the card as described according to the further embodiment;

FIG. 6 is a schematic view of layers forming the card of the further embodiment;

FIG. 7 is a plan view of the top surface of the card as described according to the further embodiment;

FIG. 8 is a plan view of the bottom surface of the card as described according to the further embodiment;

FIG. 9 is a plan view and a side view of a sheath accommodating the card of the further embodiment;

FIG. 10 is a schematic block diagram showing the functionality of button-press sequences of the card of the further embodiment;

FIG. 11 is a schematic block diagram of the functional features of a ‘list of cities’ alternative embodiment;

FIG. 12 is a schematic block diagram of the functional features of a ‘touch panel map’ alternative embodiment;

FIG. 13 is a schematic block diagram of the functional features of an ‘ATM’ alternative embodiment; and

FIG. 14 is a schematic block diagram of the functional features of a ‘map feedback’ alternative embodiment.

### DETAILED DESCRIPTION

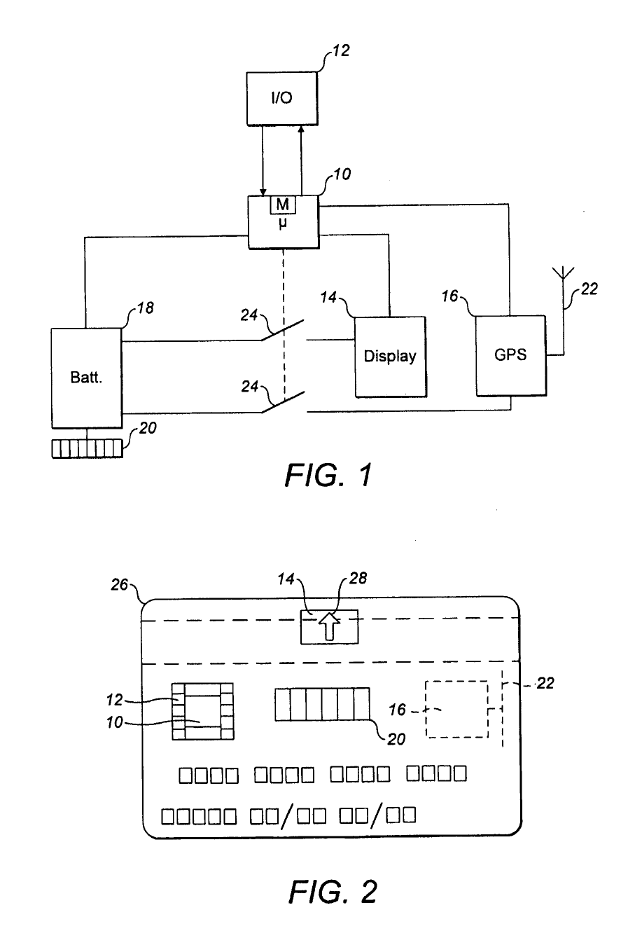

Referring to FIG. 1 of the drawings, the main functional elements of a financial transaction card according to an embodiment are shown. They comprise a processor embedded in the card in the form of a microchip 10 which includes a memory M for data storage and which has embedded interface electrical contacts 12 through which data can be exchanged with external devices either for transacting financial procedures or for the specific application to be described below. This is similar to the ‘chip and PIN1 technology found on many financial transaction cards currently available of which the skilled person will be aware. A typical example is the EMV standard for authenticating financial transactions. Other chip and PIN standards are implemented on such cards used in specific countries such as France and the United Kingdom.

The microchip 10 is also operably connected via printed circuit data transmission elements (not shown) embedded in the card to an LCD display 14 and an embedded global positioning system (GPS) chip 16. Other types of display can be used and other types of positioning system can be utilised. The display 14 and the chip 16 are powered by an embedded source 18 of electrical power connected to it by printed circuit power transmission elements (not shown). In this embodiment the source 18 is a microcell connected to a solar panel 20 by which it is charged. The device may alternatively be powered directly from the solar cell.

In this particular embodiment the GPS chip is a GNS 7560 chip, manufactured by NXP b.v., which is produced in a Wafer Level Chip Scale Packaging package. The GNS 7560 has relatively low power consumption and high sensitivity for a GPS chip. It is connected to an embedded dipole aerial 22 implemented as printed circuit board traces within the card. The dipole is a passive antenna and is suitable for use with the GNS 7560 because of the high sensitivity of the chip.

The microchip 10 is powered by the source 18. Power to the display 14 and the chip 16 are controlled by the microchip 10 through schematically represented switches 24 enabling electrical power to be delivered to the display 14 and the chip 16 only when needed.

The embodiment described above is shown in FIG. 2 which illustrates a financial transaction card 26 in which the elements are indicated by use of the same reference numbers where appropriate. The card is a laminate of upper and lower layers of a suitable plastics material and an intermediate layer of plastics defining spaces for the various components. The shape and size of the card conforms to ISO/IEC 7810:2003 ID-I standard. The card 26 can be made to be compatible with any of the financial transaction standards for transacting financial procedures through the microchip 10. In this embodiment it uses the EVM standard referred to above but can equally well be configured for any of the other financial transaction cards standards.

In addition to being a financial transaction card, in this embodiment the microchip 10 is programmed to run a timer by which it will automatically power up the display 14 and the GPS chip 16 at predetermined times. In the present example the card is also a prayer aid for the Muslim faithful and is programmed to power the display 14 and the GPS chip 16 at times of prayer in the day. These can be inputted at the time the card is ready for distribution and/or subsequently. For example, if the card is distributed by a bank it can be programmed through the interface 12 as an option when the card is inserted into an automatic bank teller machine (ATM) operated by the issuing bank. Likewise, the predetermined position data for the Kaaba (or any other site of interest) can also be uploaded as an option at the automatic bank teller through the interface contacts 12.

Because space is limited, the electrical cell is of limited capacity. To address this, the card also includes the solar cell 20 arranged in a window in the upper laminate by which the electrical cell can be recharged by placing it in a source of light for a sufficient period.

Once power has been supplied to the GPS chip and it has been enabled and has located sufficient satellites to produce a set of location coordinates for the position of the card on the earth, the data is transferred to the microchip 10. The microchip 10 is preloaded with coordinate data for the Kaaba in the memory M. The microchip 10 compares the coordinate data for the card read from the GPS chip with the coordinate data for the Kaaba stored in memory associated with the microchip. The microchip then produces bearing data for the Kaaba from the position of the card. This is converted by the microchip into data for exciting the elements of the LCD display 14 to produce an image of a pointer 28 pointing to the Kaaba. The display 14 depicts an arrow by the excitation of the LCD elements according to the direction determined by the output from the microchip 10. The microchip is programmed to turn on at the specified times and to remain on for a predetermined period, for example five minutes, to allow the user to orientate themselves.

In an alternative embodiment the card also has a manual bubble switch embedded in a surface of the card so that the user is able to activate the Kaaba bearing locator as and when they wish. This manual option is either in addition to or in place of the automatic timing provided by the microchip for self-activation as described above. In the case of manual activation of the microchip by the user, the microchip is caused to activate the display and the GPS chip via the switches 24. As described above, the microchip 10 is programmed to stay on and to provide power to the display 14 and the GPS 16 for a prescribed period only in order to conserve power.

The disclosed embodiment provides bearing data for the Kaaba from the position of the card. However, with GPS it is also necessary to arrange the GPS device in a correct way otherwise the pointed direction may be incorrect. In the above embodiment the microchip is programmed always to indicate the direction by the pointer 28 relative to North. In other words, the microchip in this embodiment interprets the GPS data as if the card was facing North along, for example, its upper edge as depicted in FIG. 2. This means the user has to orientate himself facing North when taking a bearing to the Kaaba in order for the reading to be accurate.

Of course, it is relatively easy to approximate North from the sun and the time of day, assuming the sun is visible. However as a further improvement the card 26 may also carry a miniaturised compass. The preferred type of compass is a flux gate compass such as that disclosed in U.S. Pat. No. 5,199,178 (which is incorporated herein by reference). The flux gate compass is also powered from the source of electrical energy 18 and is also enabled under the control of the microchip 10. The output of compass data can be fed by the microchip to a separate display or the LCD display 14 can be arranged to depict two visually distinct indicators, one of the compass and one for the bearing of the Kaaba.

In use, the alternative embodiment enables the user to orientate himself heading due North to then ascertain the true and accurate bearing of the Kaaba from his own position.

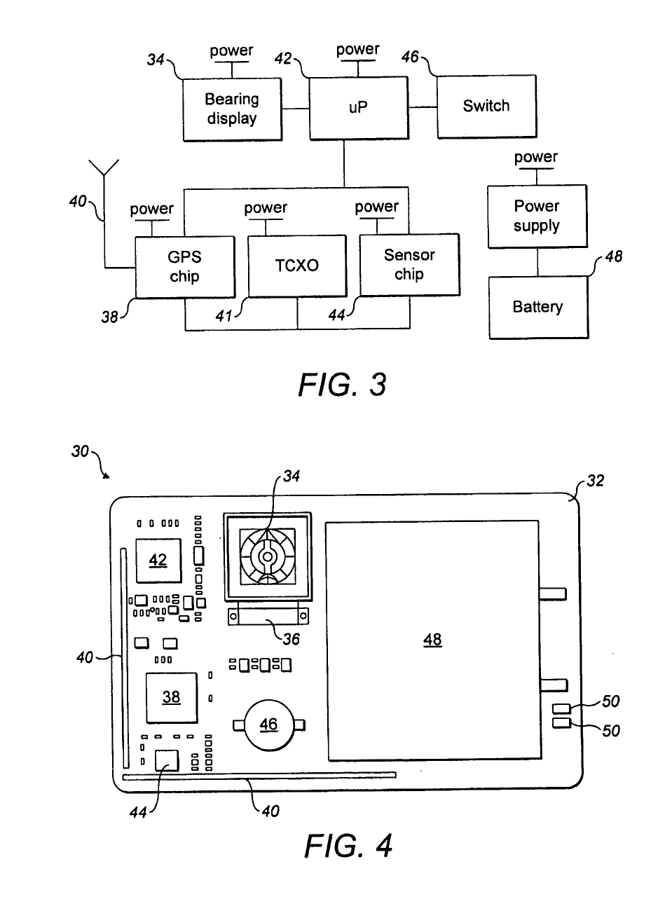

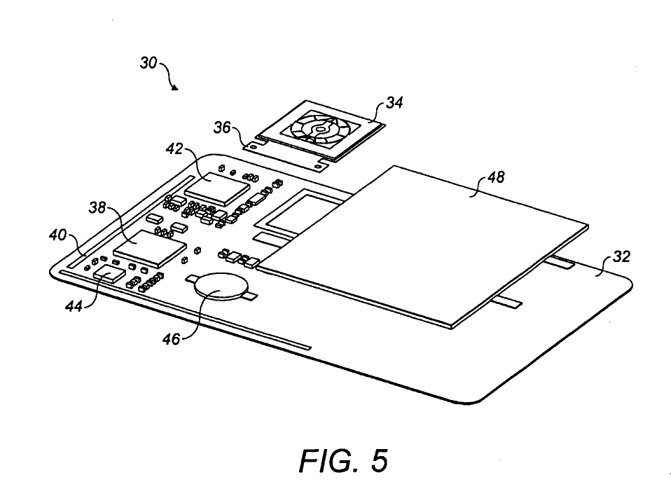

A further embodiment of a card 30, such as a financial transaction card, is described with reference to FIGS. 3-9. The features of this further embodiment are, where applicable, similar to the equivalent features of the embodiments discussed above.

Referring to FIGS. 3-5, a printed circuit board (PCB) 32 is shown. The PCB 32 is an inner layer of a financial transaction card 30 of the same dimensions referred to above. The substrate of the PCB is a plastics material, namely polyimide, which is found to have the right balance of rigidity, resilience and electrical permittivity and is commonly used in the manufacture of financial transaction cards. Various components are mounted on the PCB 32. These are interconnected as described below for power and data transfer by conventional electrically conductive elements on the PCB surface. A display 34 is mounted on the PCB 32, and is electrically connected to electrical conductors on the PCB via a display connector 36. The display device 34 comprises an electrochromic die, which undergoes a reversible oxidation reduction process on the application of a voltage. This changes the state of the die and produces a change in colour. Application of the reverse polarity voltage reverses the state. This is preferred in this embodiment because of its low power consumption and the simplicity of the required display drive arrangement. In some embodiments, the display 34 comprises an LCD or an LED display.

A GPS chip 38, such as the UBX-G5010, provided by u-blox AG, is mounted on the PCB 32. A signal input port on the GPS chip 38 is connected to an antenna 40 comprising two elements of a dipole arranged mutually at right angles in an ‘L’ configuration on the plane of the PCB surface. The antenna 40 is a shortened dipole with both elements connected, through an impedance matching network to the input of the GPS chip 38. Alternatively, other types of antenna can be used. The antenna is used to receive signals from GPS satellites. The GPS chip 38 is connected with a clock 41, which in this embodiment is based on a temperature-compensated crystal oscillator such as the KT2016 A, manufactured by Kyocera Corporation.

A processor 42, such as the ATXMEGA256-A3, manufactured by Atmel Corporation, is mounted on the PCB and is connected for data communication with the GPS chip 38 and a compass 44, such as a high sensitivity, tri-axis Hall effect sensor, for example the AK8793, manufactured by Asahi Kasei Corporation, which is also mounted on the PCB 32. As before, the compass 44 may be omitted in some embodiments. The processor 42 also comprises a memory (not shown) which stores the location coordinates of the Kaaba (or other predetermined point of interest) and also stores the location coordinates of the card 30 which are determined using the GPS chip 38. The processor 42 is switched on by the user of the card 30 pressing a bubble switch, which provides a button 46, such as a P-Switch®, manufactured by Nicomatic Corporation, for the user to press, which is mounted on the PCB 32 and is connected with the processor 42. The button 46 is either raised above or recessed below an outer surface of the card 30 so that it can be pushed, or the button 46 is flush with the card surface. In all cases, the user can apply a pushing force from a position on top of the card 30 that is above the button 46, or a pinching force from above and below the button 46, so that the button 46 is actuated.

An electrical cell or cells 48, such as a lithium-ion polymer rechargeable cell produced by General Electronics Battery Co. Ltd., is mounted on the PCB 32. The cell 48 provides electrical power for all components having electrical functionality in the card 30, including the display 34, the GPS chip 38, the processor 42, the compass 44 and the button 46. A connector 50 having at least two electrical contacts mounted on the PCB 32 extends from the PCB 32 to a lower surface of the card 30 so that the terminals are exposed. The connector 50 is connected to the cell 48 so that the cell 48 can be connected to a power source that is external to the card 30 in order to recharge the cell 48. The cell 48 is thus rechargeable in situ. As with all the disclosed embodiments the means for supplying electrical energy to the cell 48 can be through physical contact to another source of electrical power, solar derived, inductively (contactless) coupled or any other suitable means.

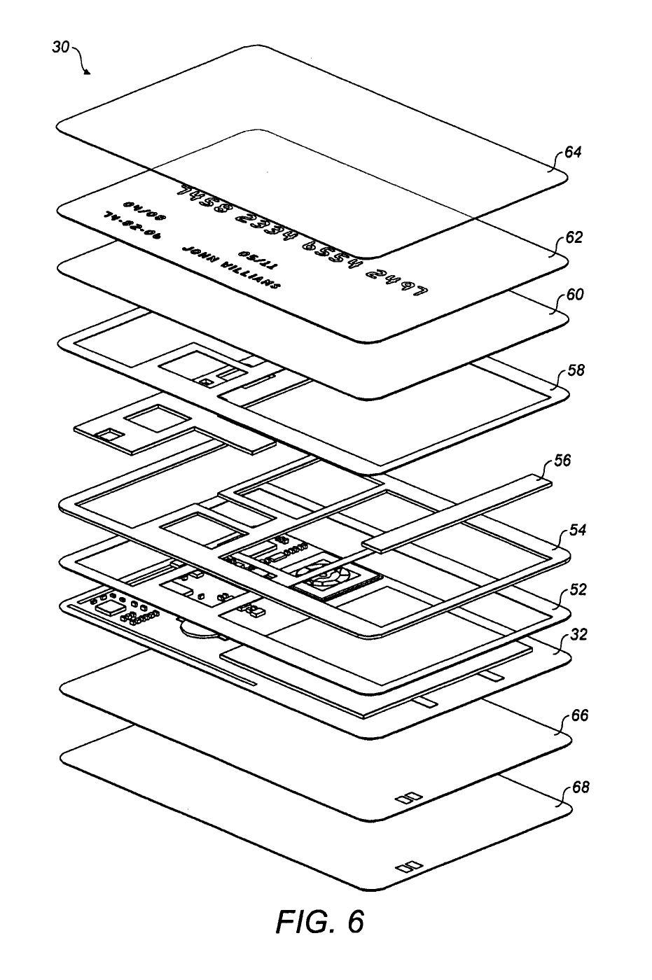

Referring to FIG. 6, the layers which form the construction of the card 30 of the further embodiment are shown schematically. The layer shown above the PCB 32 is a lower adhesive layer 52. The lower adhesive layer 52 is used to attach a core 54 of PVC to the PCB 32. The core 54 acts as a spacer and fills in some of the recesses between the components mounted on the PCB. The thickness of the core 54 is substantially the same as the amounts by which the components mounted on the PCB 32 extend above the upper surface of the PCB 32. The remaining recesses between the components which are not filled by the core 54 are filled with an epoxy 56 to the same height as the core 54. The upper surfaces of the PCB 32 components, core 54 and epoxy 56 combine to form a substantially flat surface. An upper adhesive layer 58 is applied to the upper surface of the core 54. The upper adhesive layer 58 is used to attach a capping layer 60 over the layers below it. The capping layer 60 is a structural feature which provides the desired degree of stiffness to the card 30 and protects the components mounted on the PCB 32. An upper printed layer 62 comprises a thin (relative to the capping layer 60) layer of PVC. The card number, logo, etc. are printed onto the upper surface of the upper printed layer 62. The lower surface of the upper printed layer 62 is adhesive, which allows the upper printed layer 62 to be stuck to the capping layer 60. The upper printed layer 62 is protected by an upper coverlay 64. The upper coverlay 64 is transparent such that the upper printed layer 62 can be seen by the user of the card 30. The upper printed layer 62 and the capping layer 60 both contain a hole directly above the display 34 such that the display 34 can be seen by the user of the card 30.

Attached to the opposite face of the PCB 32 is a lower printed layer 66. The lower printed layer 66 is of similar construction to the upper printed layer 62. The lower printed layer 66 has an adhesive upper surface, and information is printed onto its lower surface. The adhesive upper surface is stuck to the lower surface of the PCB 32. On the lowermost part of the card 30 is a lower coverlay 68, which protects the lower printed layer 66. The lower coverlay 68 is transparent such that the information printed on the lower surface of the lower printed layer 66 can be seen by the user of the card 30.

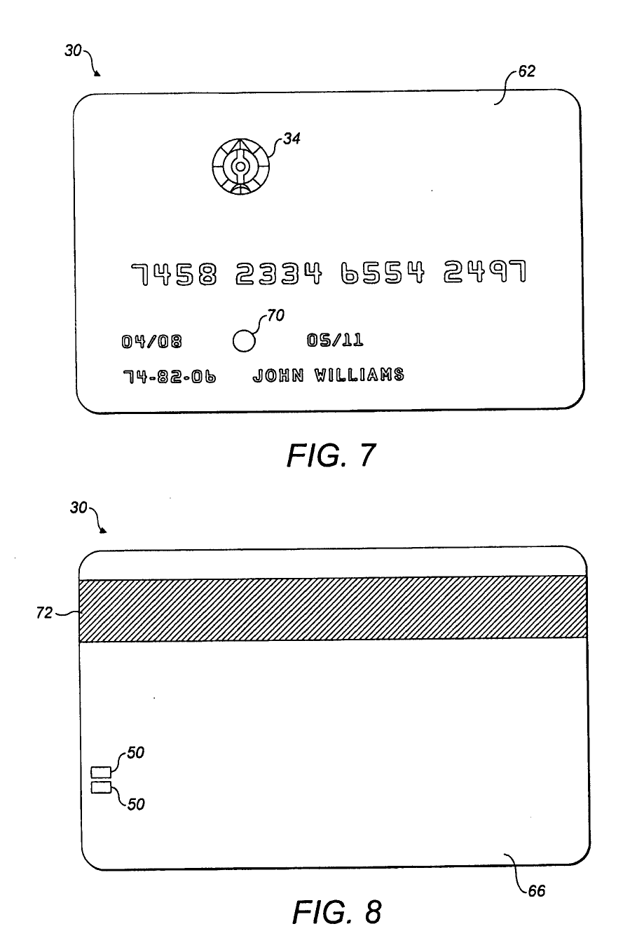

With reference to FIG. 7, a view of the upper surface of the card 30 is shown, including the upper printed layer 62, which contains standard financial transaction card information such as the card number, expiry date, etc., and the display 34. A button location indicator 70, here shown as a dot printed on the upper printed layer 62, indicates the location of the pressure point for actuating the button 46.

Referring to FIG. 8, a view of the lower surface of the card 30 is showing the lower printed layer 66, though no printed information is depicted. A conventional magnetic strip 72 is formed on the lower printed layer 66. The connector 50 is exposed through holes in the lower printed layer 66 and the lower coverlay 68 such that it can be electrically connected to a source of power external to the card 30.

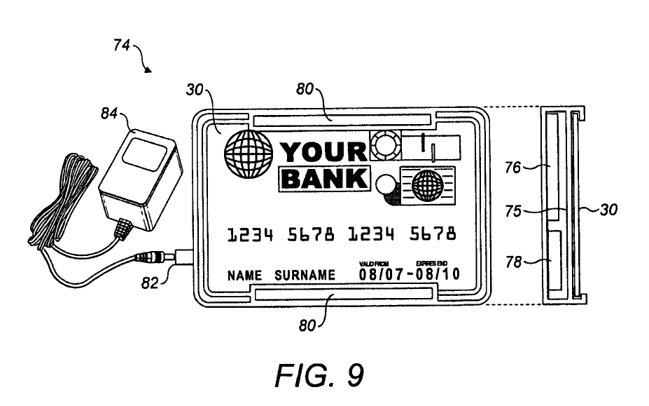

Referring to FIG. 9, a sheath 74, having a base 75, houses a second rechargeable cell or cells 76, such as a 3.7 V lithium polymer ion cell, and mains powered charging electronics 78. The sheath 74 also comprises a pair of spaced slots 80 arranged to receive and retain the card 30 as a sliding fit. The sheath 74 comprises a pair of electrical contacts (not shown) which connect with the contacts of the connector 50 when the card 30 is slid into place between the slots. When the card 30 is connected to the sheath 74, the second cell 76 can power the card 30 directly, or can provide power to the cell 48 within the card 30 in order to recharge the cell 48. Furthermore, the charging electronics 78 can be used to provide power to the second cell 76 and/or the cell 48 in the card 30, so as to recharge the second cell 76 and/or the cell 48.

In some embodiments, the second cell 76 provides power to the cell 48 in the card 30 by means of contactless charging, such as inductive charging. A first induction coil in the sheath 74 creates an alternating electromagnetic field. A second induction coil in the card 30 receives power from the alternating electromagnetic field and converts it to electrical current, which is used to charge the cell 48 in the card 30.

A disconnectable mains power jack 82 on the sheath 74 enables it to be connected to a mains power supply 84. The sheath 74 is of a similar length and width as the card 30 such that when the card 30 is accommodated within the sheath 74, the combined card 30 and sheath 74 is only slightly thicker than the card 30 on its own but of substantially the same length and width as the card 30 itself.

In a first mode of operation, the processor 42 is activated when the user presses the button 46. The processor 42 sends a request to the GPS chip 38 to provide information indicative of the position of the card 30. The GPS chip 38 receives signals from GPS satellites through the antenna 40, and from these signals is able to calculate the position data (latitude and longitude) of the position of the card 30. The position data is sent to the processor 42 and stored in the memory. Also stored in the memory are the position data of the Kaaba in Mecca. These two sets of position data are used to calculate a bearing which corresponds to the direction from the position of the card 30 to the Kaaba.

In some embodiments, this direction defines part of a great circle around the surface of the earth, such that it defines the shortest route around the surface of the earth from the position of the card 30 to the position of the Kaaba. The calculated bearing is the initial bearing of this great circle path at the location of the card 30. Alternatively, the calculated bearing from the card location to the Kaaba corresponds to the shortest rhumb line from the card location to the Kaaba. A rhumb line is a path of constant bearing across the surface of the earth. The calculated bearing is the bearing of this rhumb line. In some embodiments, the user is able to select which type of path is calculated by using the button 46. In other embodiments, the card 30 is programmed only to calculate one type of path, which makes the card 30 simpler to use.

The compass 44 is also actuated by the user having pressed the button 46. It is used to obtain compass data for determining the current orientation of the card 30. The compass data is also provided to the processor 42, which enables the processor 42 to determine the direction of the calculated bearing relative to the current orientation of the card 30. This is then indicated to the user via the display 34. In some embodiments, the compass 44 determines the current orientation of the card 30 every 0.5 seconds, to ensure that the processor 42 has the correct orientation data if the card 30 has been rotated. The display 34 comprises a circular ring divided into a plurality of segments of equal size. In the embodiment of FIG. 4 there are eight segments giving a resolution for the bearing information output of 45°. Of course, a greater number of segments will enable greater resolution. The display 34 also comprises a direction pointer. The pointer is fixed relative to the card 30. Each segment, as well as the pointer, can be activated by the processor 42. In some embodiments the display 34 is an LCD or electrochromic device, and each segment is individually connected to the processor 42 such that an electrical current applied to a segment activates it.

In use, the card 30 is held substantially horizontally or placed on a substantially horizontal surface such as the top of a table. The display 34 indicates to the user the approximate direction of the Kaaba by illuminating one of the segments appropriate to the calculated bearing. The activated segment is the segment through which the calculated path would pass if the path started from the centre of the ring. The user then rotates the card 30 so that the pointer points in substantially the direction indicated by the previously activated segment. As the card 30 is rotated, the illuminated segment will change accordingly such that the generally desired direction is continuously indicated. When the user has oriented the pointer on the card 30 to within a predetermined angle range of the direction of the calculated bearing, the pointer flashes or otherwise indicates to the user that the pointer is now pointing substantially in the direction of the Kaaba. In some embodiments, the resolution of the activation of the pointer is 5° either side of the calculated bearing, although other resolutions are clearly possible.

The user can press the button 46 again to switch off the card 30 in order to conserve power. If the user does not switch off the power then after a predetermined time, such as one minute, the card 30 will switch itself off.

The GPS chip 38 is relatively power hungry, given the limitation of the available power source. In a second, power saving, mode of operation or in an alternative embodiment, the card location data from the GPS chip 38 is stored in the memory and remains stored when the card 30 is switched off. When the device is switched on by the user pressing the button 46, if card location data is stored within the memory, the GPS chip 38 is not activated, and the previously stored card location data is used as described in the first mode of operation. After switching the device on, the user can indicate via the button 46 that he wishes the GPS chip 38 to be used to determine new card location coordinates. The new card location coordinates are stored in the memory and replace the previously stored card location coordinates. These new card location coordinates are then used as described above in the first mode of operation.

The use of the GPS chip 38 only when necessary, as requested by the user, means that the cell 48 will last longer before needing to be recharged as the GPS chip 38 will not need to be powered as much. Regular GPS location updates are not required for users of the card 30 who live a long way from Mecca, as their typical day-to-day movement will not significantly change the bearing of the Kaaba. The GPS chip 38 will therefore only need to be used when the user has traveled a significant distance. Users who live close to or in Mecca will be likely to need to use the GPS chip 38 more often to determine accurate card location coordinates.

If the GPS chip 38 cannot determine the card location coordinates, for example if the signals from enough GPS satellites are not received within a predetermined period by the antenna 40, then the processor is programmed to use the previously stored location coordinates in the memory on the assumption that the card is in a location where the GPS signals are not available. The user is informed by a suitable message or icon in the display 34 that a GPS update was not possible. In some other embodiments, if the GPS chip 38 cannot determine the card location coordinates, the card 30 is switched off automatically.

In some embodiments, the compass 44 has a calibration mode, which can be activated by the user via the button 46. The compass calibration mode enables the compass 44 in the card 30 to compensate for the effects of any magnetic material within the card 30, for example the magnetic strip 72. Within the compass calibration mode, the card 30 is first held face-up and the user presses the button 46. The user then rotates the card 30 through 180° in the horizontal plane and presses the button 46 again. The user then rotates the card 30 so that it is face-down and presses the button 46 again. At each button-press, a compass measurement is taken. The card 30 then indicates to the user via the display 34 whether or not the calibration mode was successful. In some embodiments, if the card 30 has not been calibrated previously, it will automatically activate the calibration mode after the GPS chip 38 has determined the card location coordinates.

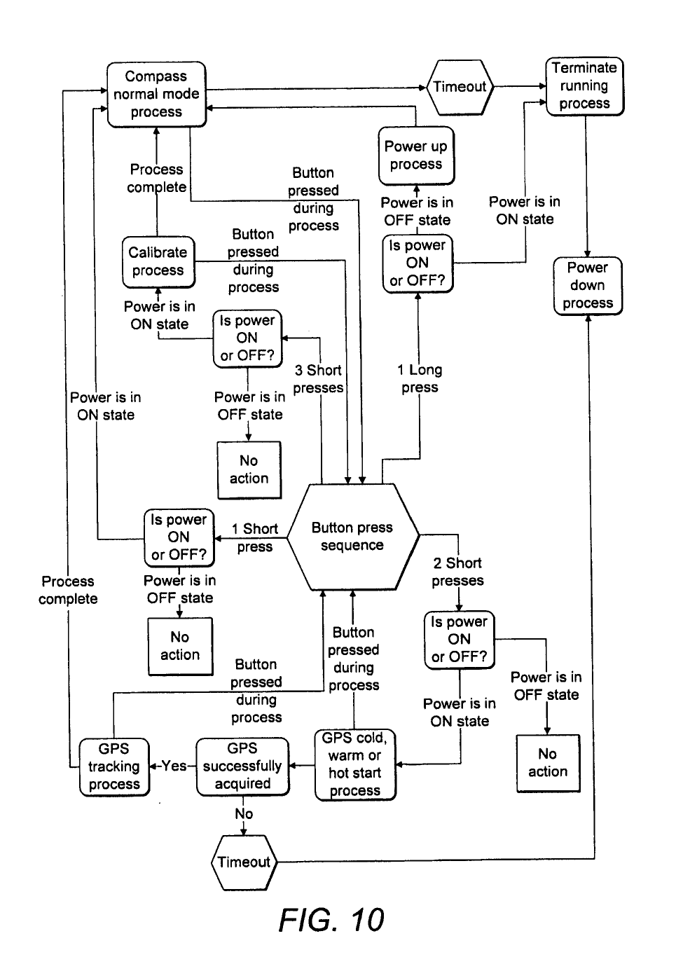

In some embodiments, the different available features on the card 30 are selected by different durations or quantities of presses of the single button, as shown in FIG. 10. For example, if the card 30 is in a switched-off state and the user presses and holds the button 46, the card 30 will switch on. If the card 30 is in a switched-on state, a similar long press of the button 46 will cause the card 30 to save any relevant data and switch off. One short press of the button 46 while the card is on selects the second, power-saving, mode of operation. Two consecutive short presses of the button 46 when the card 30 is switched on cause the GPS chip 38 to calculate new card location coordinates. Three short consecutive button presses when the card 30 is on cause the compass calibration mode to be selected. In some embodiments, the segments and pointer of the display 34 are activated in certain configurations or in certain sequences of configurations which indicate to the user the current mode of operation.

In some embodiments, the antenna 40 comprises two substantially straight elements which are arranged perpendicular to one another. In the disclosed embodiment, these two elements of the antenna 40 are each substantially parallel to a different edge of the card 30 and are situated proximal to that edge in one corner of the card.

In some embodiments, some of the functions of the GPS chip 38 are carried out by the processor 42 instead of the GPS chip 38 so that the GPS chip 38 does not need to be powered on for longer than is necessary. This means that the cell 48 does not need to provide as much power to the GPS chip 38 and hence the cell 48 will last longer before it needs to be recharged.

In some embodiments, the button 46 is a single button 46 and hence the only user input device on the card 30. In some embodiments, a user input device other than a button 46 is used.

In some embodiments, the GPS chip 38 has various start-up modes depending on whether or not it needs to download new almanac data or ephemeris data from a GPS satellite, or whether or not it has been able to keep track of time. If the almanac and/or ephemeris data are already known, then the GPS chip 38 will not download them again. This means that the GPS chip 38 can be used more quickly if the almanac and ephemeris data are already known.

In some embodiments, the card 30 comprises an accelerometer. The accelerometer is used to determine the angle of the card 30 relative to the horizontal plane. The angle of the card 30 is used with the compass 44 in determining the orientation of the card 30. In some embodiments, the location coordinates of the card 30 determined from the GPS chip 38 are used by the processor 42 to determine the angle of the earth's magnetic field relative to the horizontal plane at the position on the earth's surface corresponding with the card location coordinates. Using the accelerometer, the processor 42 can determine the angle of the card 30 relative to the earth's magnetic field and hence more accurately calculate the orientation of the card 30.

In some embodiments, the position data for the Kaaba is stored in the memory. The compass 44 initially determines the direction of the magnetic North Pole from the position of the card 30. The processor 42 then calculates the Qibla relative to the direction of the magnetic North Pole determined by the compass 44, such that the display 34 is able to indicate the Qibla.

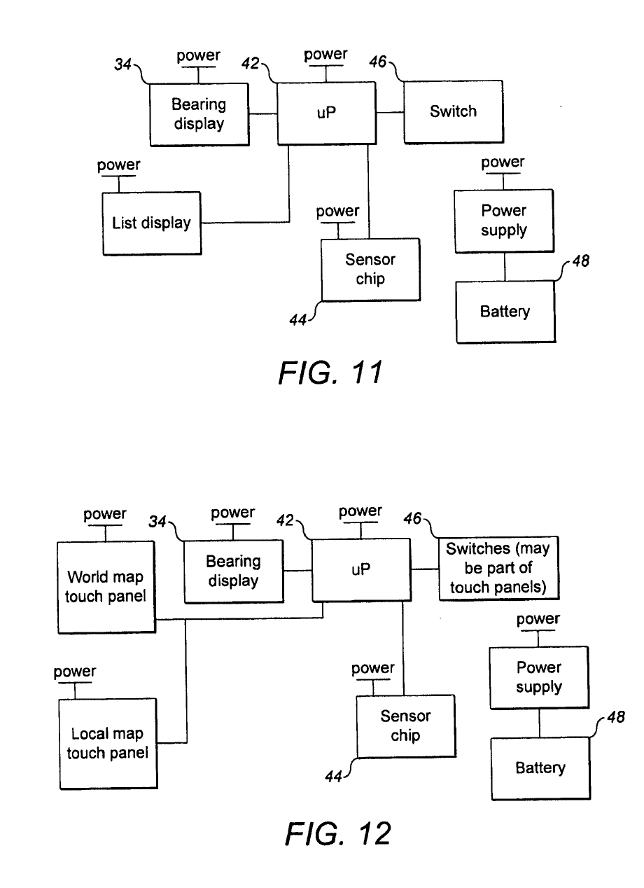

According to a further alternative embodiment, the card 30 has a list of cities and their position data stored in the memory of the processor 42. The user is able to select a city that is closest to his current location from the list. The selection is made using a user input device on the card 30 such as the button 46 or other user interface. The location coordinates of the selected city are stored in the memory and are used as described above in determining and indicating a bearing for the Kaaba. In some embodiments, this ‘list of cities’ feature complements the feature of the location coordinates being determinable using the GPS chip. The user can select which feature to use to determine the location coordinates of the card 30. In other embodiments, the ‘list of cities’ feature replaces the GPS chip 38. As the GPS chip 38 is not required, the cell 48 uses less power and hence will last for longer before needing to be recharged. This embodiment is illustrated schematically in FIG. 11.

According to another alternative embodiment, on one or both of the upper printed layer 62 and the lower printed layer 66 there is printed a touch panel map of the world. In some embodiments there is also provided one or more larger-scale touch panel maps of the area surrounding Mecca or other point of interest on the earth. The user indicates his current location by pressing on the relevant part of the touch panel map with an implement such as a stylus, pen or his finger. The location coordinates of the selected location are stored in the memory of the processor 42 and used as described above in determining and indicating a bearing for the Kaaba. In some embodiments, the touch panel map is also used by the user to switch the card 30 on or off by pressing on a part of the touch panel map. As with the ‘list of cities’ feature, this ‘touch panel map’ feature either complements or replaces the GPS chip 38. This embodiment is illustrated schematically in FIG. 12.

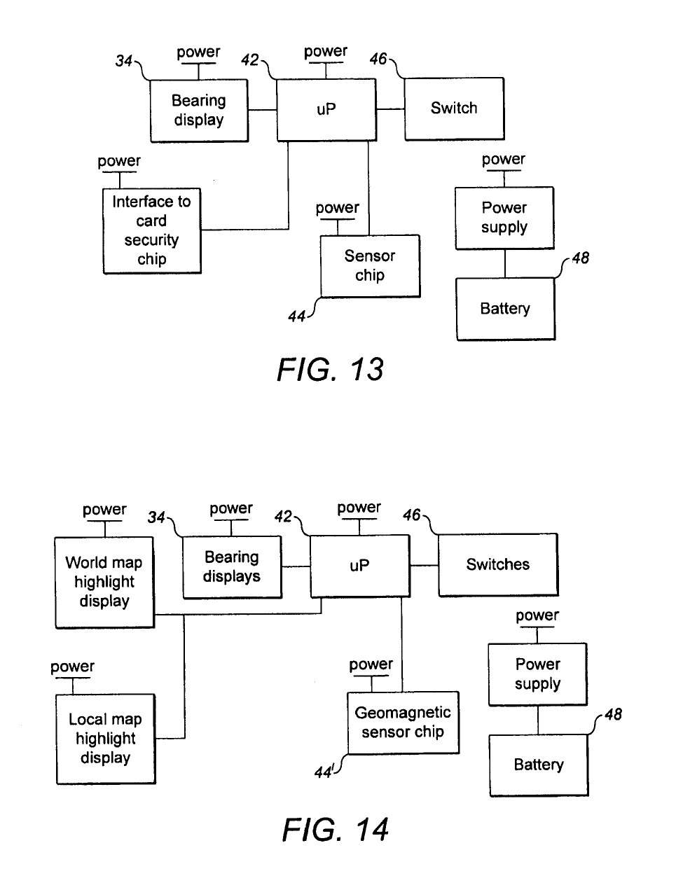

According to another alternative embodiment, the card 30 is able to retrieve current location data while it is inserted in, or otherwise in communication with, an automated teller machine (ATM), point of sale (POS) terminal or other device. The retrieved card location data corresponds with the location of the device. The retrieved card location data is stored in the memory of the processor 42 and can then be used as described above in determining and indicating a bearing for the Kaaba. The card location data in the memory is replaced with updated card location data each time the card 30 is inserted in a compatible device. As with the ‘list of cities’ feature, this ‘ATM’ feature either complements or replaces the GPS chip 38. This embodiment is illustrated schematically in FIG. 13.

According to another alternative embodiment, one or more maps are printed on the card 30. Each map is divided into segments. Each segment can be highlighted. In some embodiments, the segments are printed with bistable electrophoretic ink. The chosen map segment is permanently highlighted without needing to be powered. The display 34 is able to display a numerical bearing as well as having the features discussed above. A user input device comprising an ‘up’ button and a ‘down’ button is used to operate the card 30. In one mode of operation, the user selects a bearing manually, and the map segments for which this bearing is the correct bearing for the Kaaba are highlighted. The bearing is indicated as described above via the display 34. In another mode of operation, the user uses the user input device to select a map segment that corresponds to his current location. Location coordinates corresponding to the selected map segment are stored in the memory of the processor 42 and used as described above in determining and indicating a bearing for the Kaaba. In a third mode of operation, the user (already knowing the direction of the Kaaba) orients the card so that the pointer on the display 34 points in the direction of the Kaaba. The user then uses the user input device to initiate a calibration procedure whereby the bearing of the pointer on the display 34 is stored in the memory of the processor 42. In subsequent uses of the device, the stored bearing is indicated to the user in the same way as described above via the display 34. If the calibration procedure is repeated, the new bearing replaces the old bearing in the memory of the processor 42. As with the ‘list of cities’ feature, any of these discussed features either complements or replaces the GPS chip 38. This embodiment is illustrated schematically in FIG. 14.

It will be understood that the above description of specific embodiments of the invention is by way of example only and is not intended to limit the scope of the invention. Components used in one disclosed embodiment can be used to replace equivalent components in other embodiments. Features used in one embodiment. can be used to augment other embodiments. Many modifications and alterations of the specific embodiments described above will be apparent to a person skilled in the art and are intended to be within the scope of the appended claims.

What is claimed is:

1. A financial transaction card comprising: means for storing data; position determining means operable to determine position data for the card; means for comparing a determined position for the card from the position determining means with a predetermined position stored in the means for storing and to provide bearing data on the predetermined position from the determined position of the card; and output means for indicating the said bearing.

2. A card as claimed in claim 1 in which the output means are a display, for example a liquid crystal display or an electrochromic panel.

3. A card as claimed in claim 1 in which the output means depict a variable marker indicating the predetermined position.

4. A card as claimed in claim 1 further comprising a source of electrical power arranged to provide power to the position determining means, the means for comparing and the output means.

5. A card as claimed in claim 4 in which the source includes an electrical storage cell.

6. A card as claimed in claim 4 in which the source of electrical power is rechargeable

7. A card as claimed in claim 4 in which the source includes a solar cell.

8. A card as claimed in claim 7 in which the solar cell is arranged to charge an electrical storage cell.

9. A card as claimed in claim 8 in which the card is operable to receive power from a source external to the card

10. A card as claimed in claim 1 comprising an interface connected with the position determining means for enabling external data to be loaded into the card and stored in the means for storing data.

11. A card as claimed in claim 10 in which the interface is arranged to receive a user input for determining the position data.

12. A card as claimed in claim 11 in which the interface displays a set of locations each selectable by the user as the input of a location for determining the position data.

13. A card as claimed in claim 1 including processor means arranged to control the operation of the means for storing, the position determining means and the output means.

14. A card as claimed in claim 1 including compass means for providing compass data for the orientation of the card.

15. A card as claimed in claim 14 in which the compass means are an electronic compass.

16. A card as claimed in claim 14 in which the compass means include a flux gate compass and means for indicating a compass heading of the card.

17. A card as claimed in claim 1 including second interface means operably connected with the position determining means for exchanging data with an external device.

18. A card as claimed in claim 13 in which the processor means are operable for transacting financial procedures with an external device.

19. A card as claimed in claim 13 in which the processor means also comprise the means for comparing.

20. A card as claimed in claim 1 in which the position determining means comprise a receiver for receiving signals containing data for use by the position determining means.

21. A card as claimed in claim 20 in which the receiver is arranged to receive signals from a satellite navigation system

22. A card as claimed in claim 20 in which the receiver comprises an antenna, for example a dipole attached to the card.

23. A card as claimed in claim 22 in which the antenna comprises two co-planar elements which are substantially at a right angle and each element has one end proximal to a corner of the card.

24. A card as claimed in claim 20 in which the position determining means include a GPS receiver.

25. A card as claimed in claim 1 in which the means for storing data are operable to store the position data for the card determined by the position determining means.

26. A card as claimed in claim 25 in which the means for comparing are operable to use the position data for the card when the position determining means are inactive.

27. A card as claimed in claim 1 in which the card comprises orientation determining means for determining the orientation of the card.

28. A card as claimed in claim 27 in which the means for comparing are operable for determining the said bearing data relative to the orientation of the card from the orientation determining means.

29. A card as claimed in claim 27 in which the orientation determining means comprises angle determining means for determining an angle of the card relative to the horizontal plane, and is operable to determine the angle of the Earth's magnetic field relative to the horizontal plane from the card location coordinates for use by the orientation determining means in determining the orientation of the card.

30. A card as claimed in claim 29 in which the angle determining means comprises an accelerometer.

31. A card as claimed in claim 1 in which the card comprises means for enabling a user to actuate the card to indicate the said bearing.

32. A card as claimed in claim 31 in which the means for enabling are operable to cause the position determining means to determine position data when the card is actuated.

33. A card as claimed in claim 31 in which the means for enabling comprises a pressable switch.

34. In combination a financial transaction card, having a first source of electrical power, and a charging device having means for transferring energy for storage by the first source and a body for receiving the card in an energy transferring relationship therewith.

35. The combination of claim 34 in which the charging device has a second source of electrical power.

36. The combination of claim 35 in which the charging device is connectable to a mains power source to recharge the second power source.

37. The combination of claim 34 in which the body defines a slot for receiving the card in the energy transferring relationship.

38. The combination of claim 34 in which the card and the body each comprise electrical contacts which engage when the card is in the energy transferring relationship.

39. A financial transaction card comprising processing means and storage means for storage of electrical energy which are operably connected with the processing means, and means for receiving energy for charging the storage means with electrical energy.
